(19) United States
(12) Patent Application Publication
(10) Pub. No.: US 2023/0253148 A1
(43) Pub. Date: Aug. 10, 2023

(54) SIGNAL COUPLING DEVICE

(71) Applicant: Quantage, Inc., Taipei (TW)

(72) Inventors: Jeremy S. Chiu, Taipei (TW); Kuan-Hsiung Wei, Taipei (TW); Farid Hamidy, San Diego, CA (US)

(73) Assignee: Quantage, Inc., Taipei (TW)

(21) Appl. No.: 18/166,245

(22) Filed: Feb. 8, 2023

Related U.S. Application Data
(60) Provisional application No. 63/308,433, filed on Feb. 9, 2022.

(51) Int. Cl. H01F 38/14; H04R 9/02

(52) U.S. Cl. CPC H01F 38/14; H04R 9/025; H01F 2038/143

(57) ABSTRACT

A signal coupling device comprises a low-frequency circuit including a magnetic ring having an opening and a high-frequency circuit including a rod-shaped magnet. A first-level circuit is formed around the magnetic ring and extends between a first-level circuit input and a first-level circuit output. A second-level circuit is formed around the magnetic ring and extends between a second-level circuit input and a second-level circuit output. The high-frequency circuit includes a third-level circuit formed around the rod-shaped magnet and extends between a third-level circuit input and a third-level circuit output. A fourth-level circuit is formed around the rod-shaped magnet and extends between a fourth-level circuit input and a fourth-level circuit output. The first-level circuit output is coupled to the third-level circuit input and the second-level circuit output is coupled to the fourth-level circuit input.

### CROSS-REFERENCES TO OTHER APPLICATIONS

This application claims priority to U.S. provisional patent application Ser. No. 63/308,433, for “SIGNAL COUPLING DEVICE” filed on Feb. 9, 2022, which is hereby incorporated by reference in its entirety for all purposes.

### TECHNICAL FIELD

The present invention relates to a signal coupling device, more specifically, to a signal coupling device that adjusts a capacitance value and an/or an inductance value for efficient broadband signal transmission.

### BACKGROUND OF THE INVENTION

Differential signal transformers are used for signal transmission and generally include a toroidal magnet with one or more wires wrapped around the toroidal magnet. When an alternating current is passed through one of the wires an alternating magnetic flux is generated in the magnet which induces a current in the other wires. These transformers can be difficult to manufacture due to the winding operation which typically involves winding multiple fine wires around the toroid multiple times. As the performance requirements of the transformers increase and the electronic devices become more compact often automated manufacturing processes cannot be used, requiring manual labor. This results in increased cost and manufacturing variability which reduces yield and further increases cost. New signal transformers are needed that can meet the performance requirements, size requirements and cost requirements of new electronic devices.

### SUMMARY OF THE INVENTION

In some embodiments, an electronic device comprises a low-frequency circuit including a magnetic ring having an opening and a rod-shaped magnet. A first-level circuit is formed around at least a portion of the magnetic ring and extends between a first-level circuit input and a first-level circuit output. A second-level circuit is formed around at least a portion of the magnetic ring and extends between a second-level circuit input and a second-level circuit output. A high-frequency circuit includes a third-level circuit formed around at least a portion of the rod-shaped magnet and extends between a third-level circuit input and a third-level circuit output. A fourth-level circuit is formed around at least a portion of the rod-shaped magnet and extends between a fourth-level circuit input and a fourth-level circuit output. A primary coupling is arranged to electrically couple the first-level circuit output to the third-level circuit input. A secondary coupling is arranged to electrically couple the second-level circuit output to the fourth-level circuit input.

In some embodiments the rod-shaped magnet is positioned substantially within the opening of the magnetic ring. In various embodiments the rod-shaped magnet is positioned substantially outside the opening of the magnetic ring. In some embodiments the low-frequency circuit and the high-frequency circuit are integrated into a unitary electronic package. In various embodiments the unitary electronic package is formed using stacked layers. In some embodiments the unitary electronic package includes a receiving space sized and shaped to receive at least a portion of the magnetic ring. In various embodiments the unitary electronic package includes a plurality of coaxial vias that form a portion of the first, second, third and fourth level circuits. In some embodiments the first-level circuit input includes a first head end, a first tail end and a first tap end. In various embodiments the magnetic ring is made from a plurality of layers of a magnetic material. In some embodiments the magnetic ring is C-shaped or circular.

In some embodiments an electronic device comprises a magnetic ring having an opening and a rod-shaped magnet. A first winding is formed around at least a portion of the magnetic ring and extends between a first winding input and a first winding output. A second winding is formed around at least a portion of the magnetic ring and extends between a second winding input and a second winding output. A third winding is formed around at least a portion of the rod-shaped magnet and extends between a third winding input and a third winding output. A fourth winding is formed around at least a portion of the rod-shaped magnet and extends between a fourth winding input and a fourth winding output. A primary coupling is arranged to electrically couple the first winding output to the third winding input. A secondary coupling is arranged to electrically couple the second winding output to the fourth winding input.

In some embodiments the rod-shaped magnet is positioned substantially within the opening of the magnetic ring. In various embodiments the rod-shaped magnet is positioned substantially outside the opening of the magnetic ring. In some embodiments the magnetic ring and the rod-shaped magnet are integrated into a unitary electronic package. In various embodiments the unitary electronic package is formed using stacked layers. In some embodiments the unitary electronic package includes a receiving space sized and shaped to receive at least a portion of the magnetic ring. In various embodiments the unitary electronic package includes a plurality of coaxial vias that form a portion of the first, second, third and fourth windings. In some embodiments the first winding includes a first head end, a first tail end and a first tap end. In various embodiments the magnetic ring is made from a plurality of layers of a magnetic material. In some embodiments the magnetic ring is C-shaped or circular.

In some embodiments the present invention provides a signal coupling device, and the signal coupling device comprises: a ring-shaped non-closed magnetic ring, which has a magnetic ring opening; a low-frequency processing circuit module, which has a low-frequency processing circuit module body, a first-level circuit, and a second-level circuit, wherein the low-frequency processing circuit module body has a low-frequency processing receiving space, the low-frequency processing receiving space is provided for receiving the ring-shaped non-closed magnetic ring, the first-level circuit and the second-level circuit respectively extend around the ring-shaped non-closed magnetic ring, and the low-frequency processing circuit module body separates the first-level circuit, the second-level circuit and the ring-shaped non-closed magnetic ring to form a low-frequency processing magnetic coupling structure, and wherein the first-level circuit has a first head end, a first tail end, and a first tap end between the first head end and the first tail end, and a primary adjustment front end, a primary adjustment middle end and a primary adjustment rear end are provided between the first head end and the first tail end; the second-level circuit has a second head end, a second tail end, and a second tap end between the second head end and the second tail end, and a secondary adjustment front end, a secondary adjustment middle end and a secondary adjustment rear end are provided between the second head end and the second tail end.

A rod-shaped magnetic member, which is arranged adjacent to the magnetic ring opening; and a high-frequency processing circuit module, which has a high-frequency processing circuit module body, a third-level circuit, and a fourth-level circuit, wherein the high-frequency processing circuit module body has a high-frequency processing receiving space, the high-frequency processing receiving space is provided for receiving the rod-shaped magnetic member, the third-level circuit and the fourth-level circuit respectively extend around the ring-shaped non-closed magnetic ring, and the low-frequency processing circuit module body separates the first-level circuit, the second-level circuit and the rod-shaped magnetic member to form a high-frequency processing magnetic coupling structure, and wherein the third-level circuit has a third head end, a third tail end, and a third tap end between the third head end and the third tail end; wherein the third head end is connected to the primary adjustment front end, the third tail end is connected to the primary adjustment rear end, and the third tap end is connected to the primary adjustment middle end; the fourth-level circuit has a fourth head end, a fourth tail end, and a fourth tap end between the fourth head end and the fourth tail end; wherein the fourth head end is connected to the secondary adjustment front end, the fourth tail end is connected to the secondary adjustment rear end, and the fourth tap end is connected to the secondary adjustment middle end.

Optionally, in the signal coupling device mentioned above, the ring-shaped non-closed magnetic ring is C-shaped or elliptical.

Optionally, in the signal coupling device mentioned above, the high-frequency processing circuit module and the rod-shaped magnetic member form a package chip.

Optionally, in the signal coupling device mentioned above, the package chip is arranged in the magnetic ring opening or outside the magnetic ring opening.

Optionally, in the signal coupling device mentioned above, the package chip is arranged in front of, behind, above or below the magnetic ring opening.

Optionally, for the signal coupling device mentioned above, the signal coupling device is integrated into a laminated chip by means of an element production process of magnetic multilayer film.

Optionally, for the signal coupling device mentioned above, the primary adjustment front end is arranged between the first head end and the first tap end, the primary adjustment middle end is arranged between the first head end and the first tap end, the primary adjustment rear end is arranged between the first tap end and the first tail end; the secondary adjustment front end is arranged between the second head end and the second tap end, the secondary adjustment middle end is arranged between the second head end and the second tap end, and the secondary adjustment rear end is arranged between the second tap end and the second tail end.

Therefore, the present invention may embody a differential signal coupling device based on the transformer principle. The signal coupling device of the present invention forms a miniaturized signal coupling device by means of the component manufacturing process of magnetic multilayer film. In addition, the structure of a combination of the ring-shaped non-closed magnetic ring and the rod-shaped magnetic member is used to provide low-frequency and high-frequency signal processing to achieve the purpose of broadband signal transmission.

Numerous benefits are achieved by way of the present invention over conventional techniques. For example, embodiments of the present invention provide the ability to optimize the inductance and capacitance of the signal coupling device to decrease return loss and/or insertion loss of the system. The decreased losses can enable the differential signal transmission circuit to transmit signals further, and/or or to require less power to transmit signals the same distance as conventional techniques. The ability to optimize the inductance and capacitance over the broadband communications spectrum can also enable the differential signal transmission circuit to operate with increased efficiency over a broader range of frequencies enabling higher data transmission rates. The integration of the signal coupling device within an electronic package that employs coaxial vias and metallic circuit traces can improve consistency and yield of the devices and can enable the use of automated manufacturing techniques. These and other embodiments of the invention along with many of its advantages and features are described in more detail in conjunction with the text below and attached figures.

To better understand the nature and advantages of the present disclosure, reference should be made to the following description and the accompanying figures. It is to be understood, however, that each of the figures is provided for the purpose of illustration only and is not intended as a definition of the limits of the scope of the present disclosure. Also, as a general rule, and unless it is evident to the contrary from the description, where elements in different figures use identical reference numbers, the elements are generally either identical or at least similar in function or purpose.

### BRIEF DESCRIPTION OF THE DRAWINGS

FIG. 1 illustrates a simplified plan view of a signal coupling device, according to embodiments of the disclosure;

FIG. 2A illustrates a simplified plan view of the signal coupling device of FIG. 1 embodied an electronic package, according to embodiments of the present invention;

FIG. 2B illustrates a cross-section of a portion of the electronic package of FIG. 2A;

FIG. 3 illustrates a simplified isometric view of the electronic package shown in FIG. 2A with a portion of the body removed, for clarity;

FIG. 4 illustrates a simplified isometric closeup view of a high-frequency processing circuit module, according to embodiments of the disclosure; and

FIG. 5 illustrates a simplified simulation result of the return loss of an example signal coupling device, according to embodiments of the disclosure.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

In order to better appreciate the features and aspects of the present disclosure, further context for the disclosure is provided in the following section by discussing one particular implementation of a signal coupling device for broadband signal transmission, according to embodiments of the disclosure. These embodiments are for explanatory purposes only and other embodiments may have different configurations and/or geometries. Without departing from the principles of the present application, various winding methods and the number of winding coils can be used on the signal coupling device. In particular, the proportions and relative positions of various elements in the drawings are for exemplary purposes only, and do not represent the actual implementation of the present application. In some instances, embodiments of the disclosure are particularly well suited for use with ethernet physical layer devices because of the broadband coupling performance and the high-voltage isolation requirements.

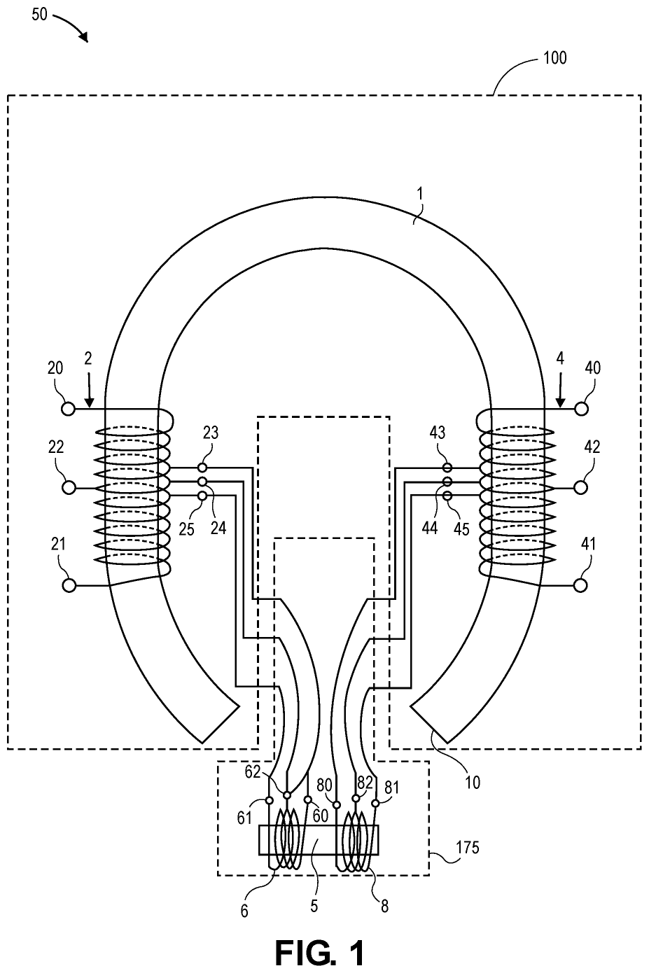

The present invention provides a signal coupling device that has optimized capacitance and inductance to achieve broadband signal transmission. FIG. 1 shows a simplified plan view of a signal coupling device, according to embodiments of the disclosure. As shown in FIG. 1, signal coupling device 50 includes a low-frequency processing circuit module 100 and a high-frequency processing circuit module 175. Low-frequency processing circuit module 100 includes an open magnetic ring 1, with a first-level circuit 2 and a second-level circuit 4 wrapped around portions of the ring. First-level circuit 2 has a first head end 20, a first tail end 21, and a first tap 22 arranged between the first head end 20 and the first tail end 21. Second-level circuit 4 has a second head end 40, a second tail end 41, and a second tap 42 arranged between the second head end 40 and the second tail end 41. A primary adjustment front end 23, a primary adjustment middle end 24, and a primary adjustment rear end 25 are arranged between the first head end 20 and the first tail end 21 of the first-level circuit 2 of the low frequency processing circuit module 100. In addition, a secondary adjustment front end 43, a secondary adjustment middle end 44, and a secondary adjustment rear end 45 are arranged between the second head end 40 and the second tail end 41 of the second-level circuit 4.

In some embodiments, the primary adjustment front end 23 is coupled to first level circuit 2 at a location positioned between the first head end 20 and the first tap end 22; the primary adjustment middle end 24 is coupled to first level circuit 2 at a location positioned between the first head end 20 and the first tap end 22; and the primary adjustment rear end 25 is coupled to the first level circuit 2 at a location positioned between the first tap end 22 and the first tail end 21. Similarly, in some embodiments the secondary adjustment front end 43 is coupled to second level circuit 4 at a position between the second head end 40 and the second tap end 42; the secondary adjustment middle end 44 is coupled to second level circuit 4 at a position between the second head end 40 and the second tap end 42; and the secondary adjustment rear end 45 is coupled to second level circuit 4 at a position between the second tap end 42 and the second tail end 41. In various embodiments the particular locations that primary adjustment front end 23, primary adjustment middle end 24 and primary adjustment rear end 25 are coupled to first level circuit 2 can be used to tune the performance of signal coupling device 50. Similarly, in various embodiments the particular locations that secondary adjustment front end 43, secondary adjustment middle end 44 secondary adjustment rear end 45 are coupled to second level circuit 4 can be used to tune the performance of signal coupling device 50.

High-frequency processing circuit module 175 includes a rod-shaped magnetic member 5 with a third-level circuit 6 and a fourth-level circuit 8 wrapped around the rod-shaped magnetic member. Third-level circuit 6 has a third head end 60, a third tail end 61, and a third tap 62 arranged between the third head end 60 and the third tail end 61. Third head end 60 is connected to the primary adjustment front end 23, third tail end 61 is connected to the primary adjustment rear end 25, and the third tap 62 is connected to the primary adjustment middle end 24.

Fourth-level circuit 8 has a fourth head end 80, a fourth tail end 81, and a fourth tap end 82 arranged between the fourth head end 80 and the fourth tail end 81. The fourth head end 80 is connected to the secondary adjustment front end 43, the fourth tail end 81 is connected to the secondary adjustment rear end 45, and the fourth tap end 82 is connected to the secondary adjustment middle end 44.

In some embodiments first level circuit 2, second level circuit 4, third level circuit 6 and fourth level circuit 8 each comprise one or more wires and in some embodiments may each comprise a copper wire with an insulative coating that may be known as “litz” wire or a similar configuration, however, in other embodiments the one or more wires may each comprise a connected series of metallic traces formed on or within a substrate which may be connected together using a plurality of vias, as explained in more detail below. In various embodiments open magnetic ring 1 and rod-shaped magnetic member 5 can be made from any suitable type of magnetic material, but not limited to a ferromagnetic material such as laminated iron, iron powder, manganese zinc compounds, nickel zinc compounds, ferrite, or other suitable material, including but not limited to nanocrystalline materials, and may be formed from a plurality of layers of a magnetic film. More specifically, in some embodiments open magnetic ring 1 and rod-shaped magnetic member may be fabricated using a multilayer process where one or both magnetic members are formed layer by layer. In various embodiments the number of magnetic layers used to form open magnetic ring 1 and/or rod-shaped magnetic member 5 can be used to adjust capacitance and/or inductance of signal coupling device 50. In some embodiments open magnetic ring 1 and rod-shaped magnetic member 5 can have any suitable cross-sectional geometry including but not limited to, circular, square, rectangular, oval, ellipsoid, C-shaped, etc. In various embodiments open magnetic ring 1 may have any suitable shape including, but not limited to an elongated circle (shown in FIG. 1) having an opening, a circle having an opening, an ellipsoid having an opening, etc. In some embodiments open magnetic ring 1 and/or rod-shaped magnetic member 5 may be positioned on, within or partially with a substrate such as, a printed circuit board (PCB), multilayer ceramic board (e.g., high-temperature co-fired ceramic (HTCC), low-temperature co-fired ceramic (LTCC)) or other suitable structure.

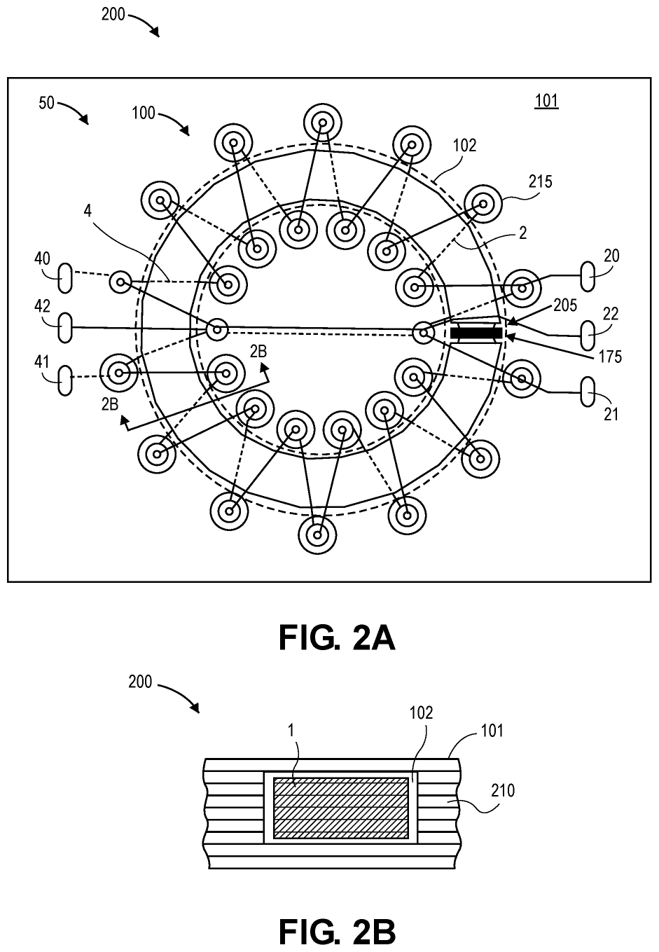

FIG. 2A illustrates a simplified plan view of signal coupling device 50 embodied an electronic package 200, according to embodiments of the present invention. Signal coupling device 50 of FIG. 2 comprises similar components as described for FIG. 1, wherein like numerals correspond to like components. Signal coupling device 50 may be or include any of the components, features, or characteristics of any of the signal coupling devices previously described.

In this embodiment open magnetic ring 1 has a circular shape with an opening 205 and rod-shaped magnetic member 5 is positioned within the opening. In other embodiments rod shaped magnetic member 5 may be positioned outside of the opening 205, for example, in front of, behind, above, adjacent, proximate or below the opening.

Electronic package 200 includes a body 101 that defines a receiving space 102 sized and arranged to receive open magnetic ring 1 and rod-shaped magnetic member 5. In some embodiments body 101 may comprise a printed circuit board or similar structure where receiving space 102 is an open or a closed region formed within the body. For example, in FIG. 2B a cross-section of an example body 101 with receiving space 102 as a closed region within a circuit board having multiple layers 210 is shown. FIG. 2B also shows an embodiment where magnetic ring 1 is fabricated from multiple stacked layers of magnetic material. In some embodiments where body comprises a PCB or similar structure, body 101 may also include one or more electrical traces that form first level circuit 2, second level circuit 4, third level circuit 6 and/or fourth level circuit 8 instead of wire, as described in FIG. 1. Further, body 101 may include one or more electrically conductive vias 215 that extend through one or more layers 210 to couple first level circuit 2, second level circuit 4, third level circuit 6 and/or fourth level circuit 8 together. In some embodiments vias 215 can be coaxial through substrate vias for improved impedance matching when the signals are coupled vertically. FIG. 2A illustrates an embodiment where high-frequency processing circuit module 175 including rod-shaped magnetic member 5 oriented perpendicular to open magnetic ring 1.

In some embodiments electronic package 200 may include one or more external terminals (not shown) that are positioned on a bottom side of body 101 and that may be used to electrically couple the electronic package to a separate substrate, such as, but not limited to surface mount pads, spheres (e.g., solder balls), columns or any other suitable interconnect structure.

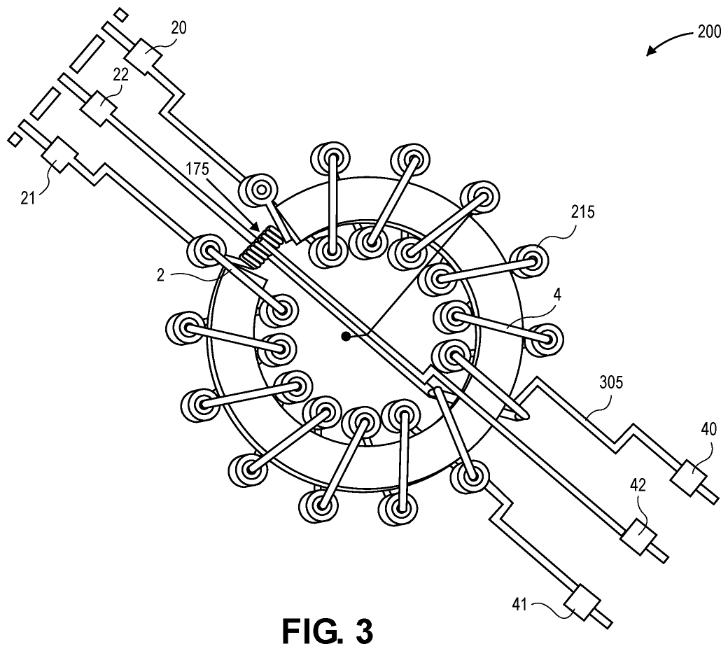

FIG. 3 illustrates a simplified isometric view of electronic package 200 of FIG. 2A with a portion of body 101 removed, for clarity. More specifically, FIG. 3 shows an embodiment where body 101 is made from a PCB or similar structure and the layers of the PCB are removed, leaving only the electrical traces 305 and the vias 215 that form first level circuit 2 and second level circuit 4. FIG. 3 also illustrates an embodiment where high-frequency processing circuit module 175 including rod-shaped magnetic member 5 oriented parallel to open magnetic ring 1.

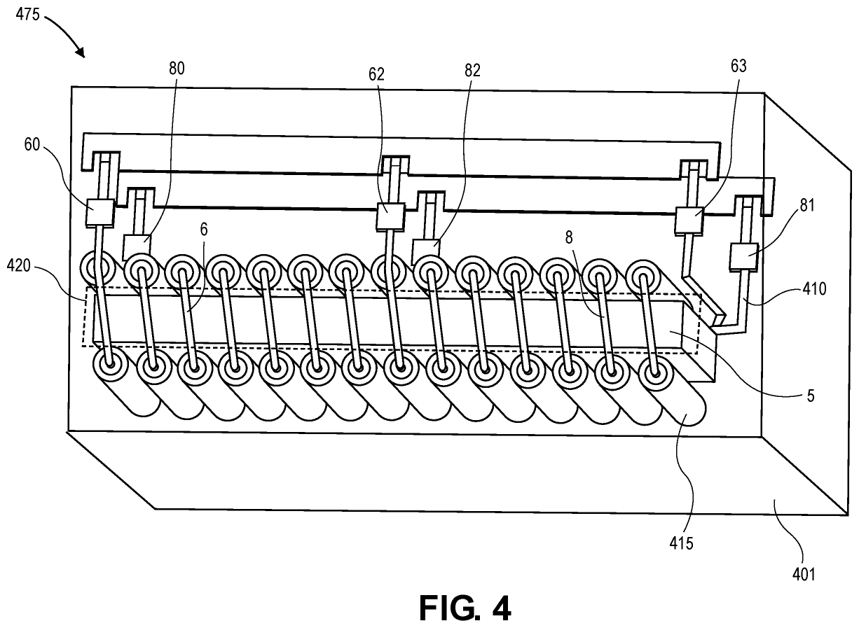

FIG. 4 illustrates a simplified isometric closeup view of high-frequency processing circuit module 475. High-frequency processing circuit module 475 may be or include any of the components, features, or characteristics of any of the high-frequency processing circuit modules previously described, and the high-frequency processing circuit module may be included in signal coupling devices or electronic packages as previously discussed. More specifically, FIG. 4 shows an embodiment where high-frequency processing circuit module body 401 is made from a PCB or similar structure and the layers of the PCB are removed, leaving only the electrical traces 410 and the vias 415 that form third level circuit 6 and fourth level circuit 8.

In some embodiments high-frequency processing circuit module body 401 can be a portion of body 101 (see FIG. 2A) while in other embodiments high-frequency processing circuit module body can be a separate body. High-frequency processing circuit module body 401 includes a receiving space 420 sized and arranged to receive rod-shaped magnetic member 5 fully or at least partially within body 401. In some embodiments receiving space 420 can be open while in other embodiments it can be closed. Third-level circuit 6 and fourth-level circuit 8 respectively wrap around the rod-shaped magnetic member 5. In some embodiments, the high-frequency processing circuit module body 401 separates the third-level circuit 6, the fourth-level circuit 8, and the rod-shaped magnetic member 5 to form a high-frequency processing magnetic coupling structure. In various embodiments high-frequency processing circuit module 175 and the rod-shaped magnetic member 5 are fabricated into an electronic package (e.g., package 200 of FIG. 2A) using a multilayer chip process, which may comprise a micro-signal coupling chip.

Third-level circuit 6 has a third head end 60, a third tail end 61, and a third tap end 62 arranged between the third head end 60 and the third tail end 61, in which the third head end 60 is connected to the primary adjustment front end 23, the third tail end 61 is connected to the primary adjustment rear end 25, and the third tap end 62 is connected to the primary adjustment middle end 24.

The fourth-level circuit 8 has a fourth head end 80, a fourth tail end 81, and a fourth tap end 82 arranged between the fourth head end 80 and the fourth tail end 81. The fourth head end 80 is connected to the secondary adjustment front end 43, the fourth tail end 81 is connected to the secondary adjustment rear end 45, and the fourth tap end 82 is connected to the secondary adjustment middle end 44.

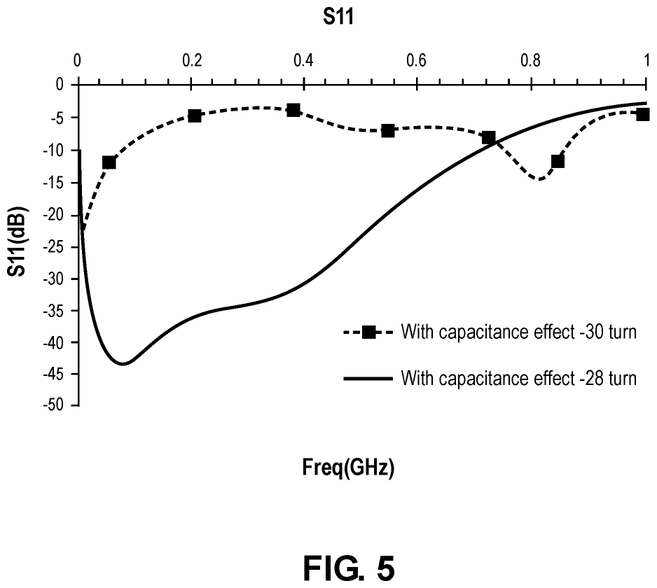

FIG. 5 illustrates a simplified simulation result of the return loss of an example signal coupling device described herein. As shown in FIG. 5 the signal coupling device described herein provides improved broadband performance as compared to prior art structures.

As shown in FIGS. 1 to 4, the signal coupling device of the present invention has the following features: (1) the ring-shaped magnetic coupling structure formed by the first-level circuit 2, the second-level circuit 4, the ring-shaped non-closed magnetic ring 1, and the linear magnetic coupling structure formed by the third-level circuit 6, the fourth-level circuit 8, and the rod-shaped magnetic member 5 utilize coaxial through substrate vias vertically through the substrate; (2) a ring-shaped non-closed magnetic ring 1 (C-typed magnetic ring) is used, for example, having a C-type structure; and (3) a rod-shaped magnetic member 5 such as a miniature signal coupling chip, and a high-frequency processing circuit module 175 are arranged adjacent to the magnetic ring opening 10 of the ring-shaped non-closed magnetic ring 1. In some embodiments coaxial through substrate vias can be used to adjust the equivalent capacitance, thereby improving the performance of S11 (e.g., return loss) at low frequency.

At relatively high frequencies, the inductance adjustment is the primary adjustment and the capacitance adjustment is the secondary adjustment. Therefore, the signal coupling device of the present invention has a relatively desirable performance at high frequency through the design of the ring-shaped non-closed magnetic ring 1, the rod-shaped magnetic member 5 and the high-frequency processing circuit module 175. This is because in the connecting wire structure formed by the linear magnetic body of the rod-shaped magnetic member, the planes between the coils are placed in parallel. In the absence of a ring-shaped magnet to guide the magnetic field lines, the structure has less leakage of the magnetic field. Therefore, the signal coupling device of the present invention can be used to adjust the capacitance value and the inductance value for overall optimization, and the purpose of broadband signal transmission can be achieved by the above three features.

In the foregoing specification, embodiments of the disclosure have been described with reference to numerous specific details that can vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction. The specific details of particular embodiments can be combined in any suitable manner without departing from the spirit and scope of embodiments of the disclosure.

Additionally, spatially relative terms, such as “bottom or “top” and the like can be used to describe an element and/or feature's relationship to another element(s) and/or feature(s) as, for example, illustrated in the figures. It will be understood that the spatially relative terms are intended to encompass different orientations of the device in use and/or operation in addition to the orientation depicted in the figures. For example, if the device in the figures is turned over, elements described as a “bottom” surface can then be oriented “above” other elements or features. The device can be otherwise oriented (e.g., rotated 90 degrees or at other orientations) and the spatially relative descriptors used herein interpreted accordingly.

Terms “and,” “or,” and “an/or,” as used herein, may include a variety of meanings that also is expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, B, C, AB, AC, BC, AA, AAB, ABC, AABBCCC, etc.

Reference throughout this specification to “one example,” “an example,” “certain examples,” or “exemplary implementation” means that a particular feature, structure, or characteristic described in connection with the feature and/or example may be included in at least one feature and/or example of claimed subject matter. Thus, the appearances of the phrase “in one example,” “an example,” “in certain examples,” “in certain implementations,” or other like phrases in various places throughout this specification are not necessarily all referring to the same feature, example, and/or limitation. Furthermore, the particular features, structures, or characteristics may be combined in one or more examples and/or features.

In some implementations, operations or processing may involve physical manipulation of physical quantities. Typically, although not necessarily, such quantities may take the form of electrical or magnetic signals capable of being stored, transferred, combined, compared, or otherwise manipulated. It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as apparent from the discussion herein, it is appreciated that throughout this specification discussions utilizing terms such as “processing,” “computing,” “calculating,” “determining,” or the like refer to actions or processes of a specific apparatus, such as a special purpose computer, special purpose computing apparatus or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

In the preceding detailed description, numerous specific details have been set forth to provide a thorough understanding of claimed subject matter. However, it will be understood by those skilled in the art that claimed subject matter may be practiced without these specific details. In other instances, methods and apparatuses that would be known by one of ordinary skill have not been described in detail so as not to obscure claimed subject matter. Therefore, it is intended that claimed subject matter not be limited to the particular examples disclosed, but that such claimed subject matter may also include all aspects falling within the scope of appended claims, and equivalents thereof.

What is claimed is:

1. An electronic device comprising:
a low-frequency circuit including:
a magnetic ring having an opening;
a first-level circuit formed around at least a portion of the magnetic ring and extending between a first-level circuit input and a first-level circuit output;
a second-level circuit formed around at least a portion of the magnetic ring and extending between a second-level circuit input and a second-level circuit output;
a high-frequency circuit including:
a rod-shaped magnet:
a third-level circuit formed around at least a portion of the rod-shaped magnet and extending between a third-level circuit input and a third-level circuit output;
a fourth-level circuit formed around at least a portion of the rod-shaped magnet and extending between a fourth-level circuit input and a fourth-level circuit output;
a primary coupling arranged to electrically couple the first-level circuit output to the third-level circuit input; and
a secondary coupling arranged to electrically couple the second-level circuit output to the fourth-level circuit input.

2. The electronic device of claim 1, wherein the rod-shaped magnet is positioned substantially within the opening of the magnetic ring.

3. The electronic device of claim 1, wherein the rod-shaped magnet is positioned substantially outside the opening of the magnetic ring.

4. The electronic device of claim 1, wherein the low-frequency circuit and the high-frequency circuit are integrated into a unitary electronic package.

5. The electronic device of claim 4, wherein the unitary electronic package is formed using stacked layers.

6. The electronic device of claim 4, wherein the unitary electronic package includes a receiving space sized and shaped to receive at least a portion of the magnetic ring.

7. The electronic device of claim 4, wherein the unitary electronic package includes a plurality of coaxial vias that form a portion of the first, second, third and fourth level circuits.

8. The electronic device of claim 1, wherein the first-level circuit input includes a first head end, a first tail end and a first tap end.

9. The electronic device of claim 1, wherein the magnetic ring is made from a plurality of layers of a magnetic material.

10. The electronic device of claim 1, wherein the magnetic ring is C-shaped or circular.

11. An electronic device comprising:
a magnetic ring having an opening;
a first winding formed around at least a portion of the magnetic ring and extending between a first winding input and a first winding output;
a second winding formed around at least a portion of the magnetic ring and extending between a second winding input and a second winding output;
a rod-shaped magnet;
a third winding formed around at least a portion of the rod-shaped magnet and extending between a third winding input and a third winding output;
a fourth winding formed around at least a portion of the rod-shaped magnet and extending between a fourth winding input and a fourth winding output;
a primary coupling arranged to electrically couple the first winding output to the third winding input; and
a secondary coupling arranged to electrically couple the second winding output to the fourth winding input.

12. The electronic device of claim 11, wherein the rod-shaped magnet is positioned substantially within the opening of the magnetic ring.

13. The electronic device of claim 11, wherein the rod-shaped magnet is positioned substantially outside the opening of the magnetic ring.

14. The electronic device of claim 11, wherein the magnetic ring and the rod-shaped magnet are integrated into a unitary electronic package.

15. The electronic device of claim 14, wherein the unitary electronic package is formed using stacked layers.

16. The electronic device of claim 14, wherein the unitary electronic package includes a receiving space sized and shaped to receive at least a portion of the magnetic ring.

17. The electronic device of claim 14, wherein the unitary electronic package includes a plurality of coaxial vias that form a portion of the first, second, third and fourth windings.

18. The electronic device of claim 11, wherein the first winding includes a first head end, a first tail end and a first tap end.

19. The electronic device of claim 11, wherein the magnetic ring is made from a plurality of layers of a magnetic material.

20. The electronic device of claim 11, wherein the magnetic ring is C-shaped or circular.
